(19) United States
(12) Patent Application Publication
(10) Pub. No.: US 2021/0295036 A1
(43) Pub. Date: Sep. 23, 2021

(54) SYSTEMATIC LANGUAGE TO ENABLE NATURAL LANGUAGE PROCESSING ON TECHNICAL DIAGRAMS

(71) Applicant: International Business Machines Corporation, Armonk, NY (US)

(72) Inventors: Prerna Agarwal, New Delhi (IN); Nitin Gupta, Saharanpur (IN); Shashank Mujumdar, Nagpur (IN); Arun Kumar, Noida (IN)

(21) Appl. No.: 16/822,687

(22) Filed: Mar. 18, 2020

(51) Int. Cl. G06K 9/00; G06F 40/56

(52) U.S. Cl. CPC G06K 9/00476; G06F 40/56

(57) ABSTRACT

One embodiment provides a method, including: receiving a technical diagram comprising a plurality of nodes and edges, wherein each edge connects two of the plurality of nodes; extracting, from the technical diagram, entities represented within the technical diagram, wherein the entities are extracted from the nodes and edges; creating groupings of entities from the extracted entities by grouping entities into groups based upon a logical relationship between the entities within a given group; generating, from the groupings, a visual representation of the technical diagram, wherein the visual representation comprises the groupings being represented as text and arranged based upon contextual relationships between the groupings; and providing a natural language summary of the technical diagram, wherein the providing comprises converting the visual representation into natural language text.

### BACKGROUND

Natural language is the language that people use to communicate with each other and that has developed naturally over time based upon communications between humans. Natural language is contrasted with machine language which is the language that computing systems and devices use to communicate and store information. Natural language processing (NLP) allows for computing devices to either process natural language into machine language or analyze an object utilizing machine language and provide an output of the analysis in natural language. For example, a computing device can analyze an image and provide an output of natural language text related to that image.

### BRIEF SUMMARY

In summary, one aspect of the invention provides a method, comprising: receiving a technical diagram comprising a plurality of nodes and edges, wherein each edge connects two of the plurality of nodes; extracting, from the technical diagram, entities represented within the technical diagram, wherein the entities are extracted from the nodes and edges; creating groupings of entities from the extracted entities by grouping entities into groups based upon a logical relationship between the entities within a given group; generating, from the groupings, a visual representation of the technical diagram, wherein the visual representation comprises the groupings being represented as text and arranged based upon contextual relationships between the groupings; and providing a natural language summary of the technical diagram, wherein the providing comprises converting the visual representation into natural language text.

Another aspect of the invention provides an apparatus, comprising: at least one processor; and a computer readable storage medium having computer readable program code embodied therewith and executable by the at least one processor, the computer readable program code comprising: computer readable program code configured to receive a technical diagram comprising a plurality of nodes and edges, wherein each edge connects two of the plurality of nodes; computer readable program code configured to extract, from the technical diagram, entities represented within the technical diagram, wherein the entities are extracted from the nodes and edges; computer readable program code configured to create groupings of entities from the extracted entities by grouping entities into groups based upon a logical relationship between the entities within a given group; computer readable program code configured to generate, from the groupings, a visual representation of the technical diagram, wherein the visual representation comprises the groupings being represented as text and arranged based upon contextual relationships between the groupings; and computer readable program code configured to provide a natural language summary of the technical diagram, wherein the providing comprises converting the visual representation into natural language text.

An additional aspect of the invention provides a computer program product, comprising: a computer readable storage medium having computer readable program code embodied therewith, the computer readable program code executable by a processor and comprising: computer readable program code configured to receive a technical diagram comprising a plurality of nodes and edges, wherein each edge connects two of the plurality of nodes; computer readable program code configured to extract, from the technical diagram, entities represented within the technical diagram, wherein the entities are extracted from the nodes and edges; computer readable program code configured to create groupings of entities from the extracted entities by grouping entities into groups based upon a logical relationship between the entities within a given group; computer readable program code configured to generate, from the groupings, a visual representation of the technical diagram, wherein the visual representation comprises the groupings being represented as text and arranged based upon contextual relationships between the groupings; and computer readable program code configured to provide a natural language summary of the technical diagram, wherein the providing comprises converting the visual representation into natural language text.

A further aspect of the invention provides a method, comprising: receiving a diagram comprising nodes and edges, wherein each edge connects two of the nodes; generating tokens corresponding to entities within the diagram, wherein the generating comprises utilizing at least one information extractor to extract objects from the nodes and edges; grouping the tokens into logical groupings, wherein a given logical grouping comprises tokens having a contextual relationship within the diagram; representing the logical groupings as a visual representation, wherein the visual representation comprises the logical groupings (i) arranged and (ii) connected by identifying a contextual relationship between the logical groupings; and producing a natural language summary of the diagram by converting the visual representation into natural language text, the converting comprising utilizing a natural language processing analysis technique on the visual representation.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of generating a natural language summary of a technical diagram by converting the technical diagram into a visual representation that can be processed utilizing natural language processing techniques.

FIG. 2 illustrates an example technical diagram for producing a natural language summary.

FIG. 3 illustrates an example system architecture for generating a natural language summary of a technical diagram by converting the technical diagram into a visual representation that can be processed utilizing natural language processing techniques.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

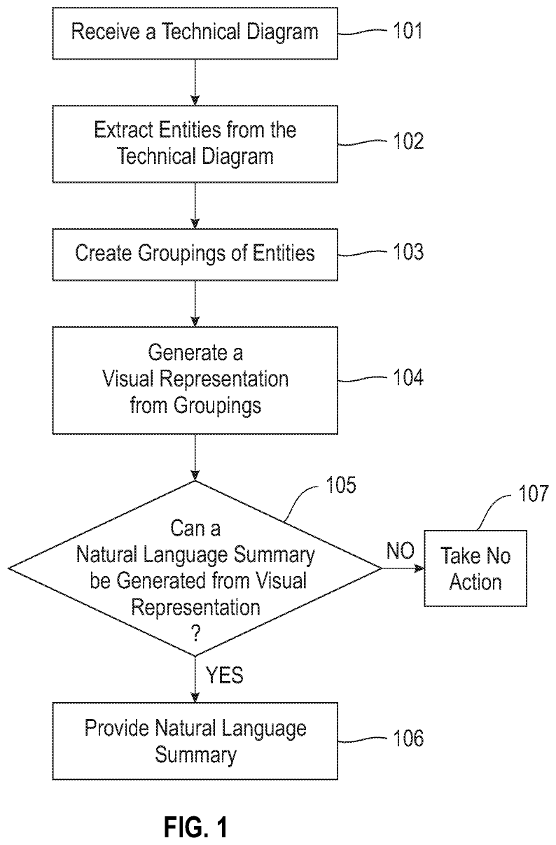

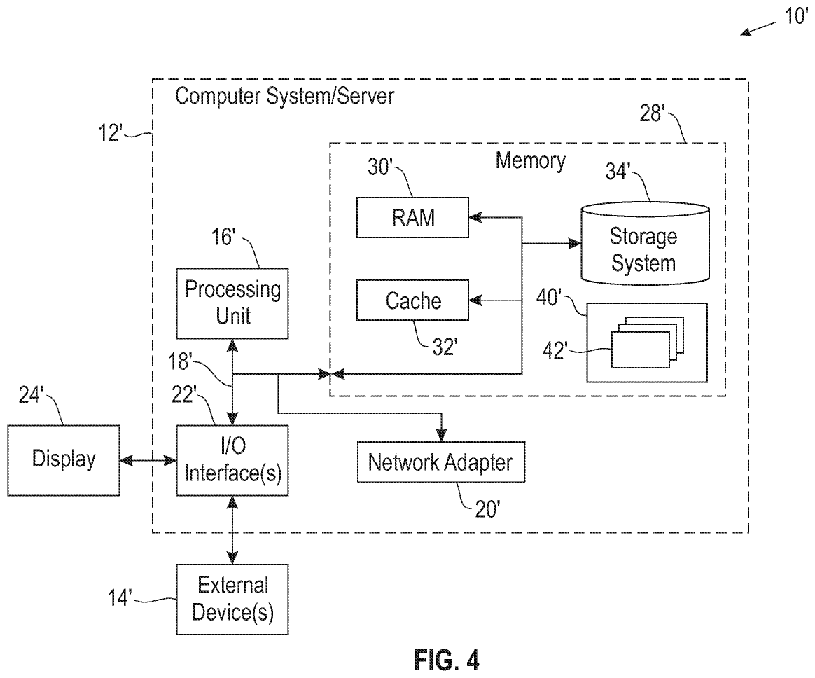

Specific reference will be made here below to FIGS. 1-4. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIGS. 1-3 can be performed or utilized by way of a processing unit or units and system memory such as those indicated, respectively, at 16′ and 28′ in FIG. 4, whether on a server computer, a client computer, a node computer in a distributed network, or any combination thereof.

Natural language processing (NLP) has significantly improved with the improvement of machine-learning models, training datasets, and other training algorithms. As the natural language processing techniques become more intelligent, the techniques are utilized more frequently for converting information into a natural language format utilizing a computing system, which may be as simple as a smartphone or other portable device or as complex as a cloud computing system. Thus, users are increasingly utilizing computing devices to analyze information and provide a natural language output so the user does not have to manually perform such an analysis. However, natural language processing does have some deficiencies where the computing device is unable to accurately analyze and process information into a natural language text because natural language processing is unable to identify relationships within the presented information, which prevents the system from be able to provide a natural language output.

One area of deficiency for conventional natural language processing techniques is the conversion of technical diagrams (e.g., tables, flowcharts, architecture diagrams, system diagrams, workflow diagrams, process diagrams, etc.) to natural language output. The problem with technical diagrams is that much of the information and context of the diagram is derived from edge connections, diagram shapes, short phrases, and the like. While a human can understand the technical diagram based upon the information provided within the technical diagram, a computing device is unable to perform the same analysis. Thus, while computing systems can utilize natural language processing techniques to provide natural language output regarding natural images (e.g., images of people, objects, things, etc.), the computing systems are unable to perform the same analysis on technical diagrams, since the technical diagrams do not include the same semantic meaning and relationships as found in natural images.

Another problem with utilizing natural language processing on technical diagrams is that technical diagrams can be found in many different formats, with different formats having different meanings for similar objects. For example, in one technical diagram format a rectangle shape may have one meaning, whereas within a different technical diagram format the rectangle shape may have a different meaning. Thus, a natural language processing algorithm has to be trained to recognize the format of the technical diagram and then utilize rules associated with the recognized format in order to identify information within the technical diagram. Programming the natural language processing technique to recognize all of these formats and all of these rules is time-consuming, tedious, and likely error-prone.

Accordingly, an embodiment provides a system and method for generating a natural language summary of a technical diagram by converting the technical diagram into a visual representation that can be processed utilizing natural language processing techniques. The system receives a technical diagram (e.g., table, flowchart, architecture diagram, system diagram, workflow diagram, process diagram, etc.). The technical diagram includes a plurality of nodes and edges, with the edges connecting nodes within the technical diagram. For example, the system may receive a flowchart that includes boxes, which correspond to nodes, and lines connecting the boxes, which correspond to edges. From the technical diagram the system extracts entities that are represented within the technical diagram. These entities can be extracted from the nodes and edges within the technical diagram. Entities correspond to objects, labels, shapes, or the like, within the technical diagram. In other words, an entity represents the smallest unit within the technical diagram. As an example, entities may include object names, edge labels, shape functions, and the like.

The system creates groupings of the extracted entities. The entities within each group have a logical relationship. These groupings mimic groupings of entities in a natural language. For example, the groupings may mimic those entities that would be included within a sentence. The system may also make larger groupings of smaller groupings. For example, the system may group entities that are within sentence groupings into a paragraph grouping. Since the entities are grouped within logical groupings that are similar to natural language groupings, the system can generate a visual representation of the technical diagram from the groupings. From the visual representation the system can provide a natural language summary of the technical diagram. More specifically, the system can convert the visual representation into natural language text utilizing conventional natural language processing techniques on the visual representation.

Such a system provides a technical improvement over current systems for producing summaries for technical diagrams. The described system and method utilize extraction techniques that can extract entities from technical diagrams of any format. The system and method then group the entities into logical groupings that are similar to natural language groupings, for example, sentences, paragraphs, and the like. With these logical groupings the system can generate a visual representation. Conventional natural language processing techniques can then be used on the visual representation to generate a natural language summary or other output regarding the technical diagram. Thus, the natural language processing techniques only have to be able to analyze the visual representation and are not required to be able to analyze all types or formats of technical diagrams. Rather, the described system and method are able to convert any type or format of technical diagram into the visual representation and then conventional natural language processing techniques can be utilized to convert the visual representation into a natural language output. Accordingly, the described system and method provide a technique for analyzing technical diagrams of any format and providing natural language output related to the technical diagram that is more efficient, faster, and accurate than conventional techniques.

FIG. 1 illustrates a method for generating a natural language summary of a technical diagram by converting the technical diagram into a visual representation that can be processed utilizing natural language processing techniques. At 101 the system receives a technical diagram including a plurality of nodes and edges. Edges are lines or connectors that connect two of the nodes. Receipt of the technical diagram may include a user uploading the technical diagram to the system or may include the user providing a pointer or link to a location where the technical diagram is located, for example, on the Internet, within a data storage location, or the like. Additionally, or alternatively, receipt of the technical diagram may include the system accessing a known data storage location and retrieving the technical diagram. For example, all technical diagrams for processing by the system may be stored in a predetermined data storage location. The system can access this data storage location and retrieve the technical diagram. In other words, receipt of the technical diagram may be performed utilizing any technique for receiving, accessing, or otherwise obtaining the technical diagram.

A technical diagram may include any type of diagram, flowchart, figure, table, or the like, that has nodes and edges. Examples of technical diagrams include flowcharts, system architecture diagrams, process diagrams, workflow diagrams, system diagrams, and the like. The system is able to perform the discussed analysis on any type or format of technical diagram that includes nodes and edges. Thus, the shapes, formats, connectors, text, or other features utilized within different technical diagrams do not reduce the effectiveness of the described system. Additionally, the technical diagram formats provided to the system do not all have to have consistent object meanings. For example, the same geometric shape across different technical diagram formats may have different meanings. The described system is able to accurately process and analyze these inconsistent object meanings.

At 102 the system extracts entities from the technical diagram. Entities can be extracted from the nodes and edges of the technical diagram or any other portion of the technical diagram that includes text or represents a function within the technical diagram. For example, entities can be extracted from the geometric shapes included within the technical diagram regardless of whether the shape includes text. In order to extract the entities, the system decomposes the technical diagram into units. The system can then analyze the decomposed technical diagram and units and utilize information extractors to extract minimal units or entities from the decomposed technical diagram. The minimal units correspond to the entities. Entities can correspond to objects, layers, functions, or any other thing within the technical diagram. If an entity was described in natural language terms, each entity would be equivalent to a word.

To extract entities, the system may use different classification techniques. The chosen classification technique may be based upon the object that is being defined into an entity. For example, the system may classify text into an entity. The system may extract text from the technical diagram, for example, text included as an edge label, text included within a node, text associated with a node, text included in the title, legend, or other object within the technical diagram, or the like. Extracting the text may include using text extraction techniques, for example, annotators, information extractors, text parsers, and the like. The system may then classify the extracted text into one or more entities. For example, if the extracted text includes a phrase or sentence, the system may identify more than one entity within the extracted text. Classifying text into an entity may be performed utilizing different text classification techniques, for example, parts-of-speech analysis, text annotators, semantic analysis techniques, or the like, to identify the text that corresponds to an entity.

As another example, the system may classify objects into entities. As an example, the system may classify geometric shapes, for example, the shapes of the nodes, the edges, or the like, into different entities. Generally, each geometric shape within a technical diagram has a corresponding function. As an example, in a business process model, a diamond shape corresponds to a decision task and a rectangle corresponds to an activity. Thus, each geometric shape has a certain meaning or definition. This meaning or definition can act as an entity. Thus, the meaning or definition of a geometric shape can be identified and classified into an entity of the technical diagram. Edges may represent a temporal relationship between nodes connected by the edge and may, therefore, have a corresponding function that can be classified into an entity.

To identify the meaning or definition of a shape or edge type, the system may access a database that includes shapes and corresponding shape meanings. When accessing the database, the system also takes into account the type or format of the technical diagram. Since different types or formats of technical diagrams may have different meanings for shapes, the system accesses the shape and corresponding meaning for the particular technical diagram format. Upon identifying a match between the technical diagram format and shape within the database, the system can assign that meaning or definition to the shape and then extract an entity based upon that meaning or definition.

Once the entities are extracted each entity is identified as a token within the technical diagram. Thus, tokens correspond to the minimal unit which the technical diagram can be decomposed into. From the tokens, further abstractions or groupings can be created. Thus, at 103, the system creates groupings of entities or tokens that were extracted at 102. In creating the groupings, the system groups entities or tokens into groups that have a logical relationship. In other words, the entities or tokens within a given grouping have a logical relationship with other entities or tokens within that grouping. A logical relationship refers to a dependency, contextual, or semantic relationship between the tokens included in the grouping.

A first type of grouping that may be created is a grouping that is equivalent to natural language phrases or sentences. To generate a token phrase the system may utilize rules that are learned by the system or provided by a user. These rules may identify collections of shapes and/or tokens that, when arranged in a particular order or specific arrangement, have an identified functionality. For example, if an identified series of shapes corresponds to a particular functionality, then whenever this series of shapes is encountered within the technical diagram, the system will group the tokens corresponding to this series of shapes into a token phrase. In other words, from the arrangement of the shapes, the system can identify the relationship between the tokens represented in those shapes.

To generate a token sentence, the system may group the tokens which are dependent upon each other within the technical diagram. For example, the system may first select a starting node, and token corresponding to that starting node, and then select an ending node, and token corresponding to that ending node. The system then traverses the technical diagram from the starting node to the ending node and collects all tokens that correspond to nodes or edges that were traversed within the path. These tokens are then grouped into a token sentence. In generating the token sentence, the system combines those token phrases that are included in the path into the token sentence along with the other encountered tokens. The system may combine the token phrases and/or other encountered tokens into a token sentence by utilizing some semantic analysis to add semantic meaning to the token sentence.

To generate a token sentence that makes sense, the system may utilize a logical or semantic grouping or ordering of the tokens and/or context included in the technical diagram. To assist in identifying a logical or semantic grouping or ordering of the tokens, the system may utilize diagram tags. Diagram tags are equivalent to parts-of-speech tags as used in natural language processing techniques. Thus, the diagram tags identify a function of a token. Tokens having a similar functionality can then be grouped together. Diagram tags can be identified based upon known entities and functions. In other words, the system may have rules, databases, or the like, that identify that particular entities have a particular function. For example, a database token may be associated with a function of storing information. The function may be identified using a pre-defined class of entities or shapes. In other words, the function of a token may be identified from the entity name, shape associated with the entity, or a combination thereof.

To identify the context, the system may identify a relationship between tokens. In other words, the system may determine how the tokens are connected to each other within the technical diagram. This relationship can be used while establishing a semantic understanding of the token sentence path through the technical diagram. These relationships frequently correspond to edge labels. In other words, the labels or entities associated with an edge connecting two nodes may provide the context or semantic relationship between the tokens corresponding to the connected nodes. In a situation where a relationship between tokens is not explicitly identified within the technical diagram, the system may determine the context through the diagram tags corresponding to the connected tokens. For example, a relationship corresponding to a connection to a database may be inferred or identified from the fact that a database stores information. Thus, the semantic relationship between the entity corresponding to a node connected to the database node and the database node is that the entity is storing, sending, or executing information to the database.

From the token sentences, the system can generate token paragraphs which are a collection of sentences and are equivalent to natural language paragraphs. Similar to the techniques used in generating the token sentences, the system takes into account a logical flow or semantic relationship between token sentences included in the token paragraph. In other words, the token sentences included in a token paragraph are those token sentences that are dependent upon each other or have some logical or semantic relationship to other token sentences included in the token paragraph. To assist in generating the token paragraph, the system may utilize text or language analysis techniques to identify dependencies, for example, redundant sentence identification, Term Frequency-inverse document frequency (TF-idf) of tokens across token sentences, or the like.

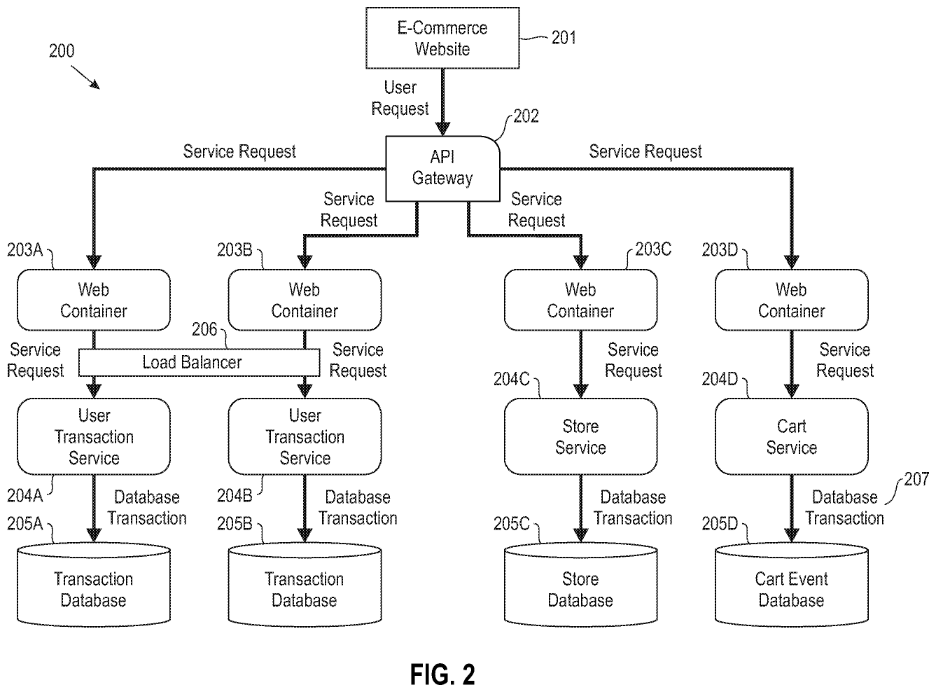

FIG. 2 provides an example technical diagram 200 that includes nodes and edges. The entities represented in this example technical diagram are those things represented by the nodes and edges. For example, some entities include “E-Commerce Website” 201, “API gateway” 202, “Web Container” 203A-203D, “User Transaction Service” 204A-204D, “Transaction Database” 205A-205B, “Store Database” 205C, “Cart Event Database” 205D, “Load Balancer” 206, “Database Transaction” 207, “Service Request”, “User Request”, and the like. Other entities or tokens may be represented by shape or edge definitions or meanings.

As an example of generating a token phrase with the example illustrated in FIG. 2, assume that the user has provided, or the system has learned, a rule that a rectangle shape, for example, 204A, followed by a cylinder shape, for example 205A, results in “<token_1> executes <context> to <token_2>”. Thus, upon encountering the combination of 204A connected to 205A, the system would generate a token phrase “User Transaction Service executes transaction to Transaction database.” In this example, the context tag, “transaction”, has no functionality tag within the rules database. Other example rules may include rules that have functionality tags, different contexts, or the like. These rules would result in corresponding token phrases.

As an example of generating a token sentence using the example of FIG. 2, the system may select the “E-Commerce Website” 201 as the starting node and the “Transaction Database” 205A as the ending node. Traversing the path between these nodes, the system, in addition to the tokens corresponding to the starting and ending nodes, collects the tokens corresponding to “API Gateway” 202, “Web Container” 203A, “Load Balancer” 206, and “User Transaction Service” 204A. To generate the token sentence, the system utilizes diagram tags and context identified within the technical diagram. As an example of diagram tags with the example illustrated in FIG. 2, each of the entities and/or entity shapes has an identified functionality. For example, the “Load Balancer” 206 has a functionality corresponding to a router of high volume information. As another example, “Transaction Database” 205A, “Store Database” 205C, and “Cart Event Database” 205D, all have database functionalities. Similar functionality can be identified for the other entities within the technical diagram. Identifying the context, the system identifies that “User Request”, “Service Request”, and “Database Transaction” is the text corresponding to the encountered edges. Thus, using the token phrases, encountered tokens, diagram tags, and identified context, the system can generate a token sentence that states “E-Commerce Websites sent user request to API gateway that generates service requests to web containers which sent service request to load balancer which routes high volume of service requests to User Transaction Service which executes transaction to Transaction Database.”

When token sentences are generated for the entire technical diagram of FIG. 2, four token sentences are generated. The system can then aggregate the token sentences into a token paragraph. Utilizing TF-idf, the system identifies that each sentence includes a “Web Container” token. In other words, utilizing TF-idf, the system identifies four “Web Container” tokens. This information can be used to generate the token paragraph so that it flows and reduces redundancy within the token paragraph. A resulting token paragraph may read “E-Commerce Websites sent user request to API gateway that sent service requests to four web containers. First and Second web container generates service request to load balancer that routes high volume of service requests to User Transaction Service which executes transaction to Transaction database. Third web container generates service request to Store Service which executes transaction to Store database. Fourth web containers generates service request to Cart Service which executes transaction to Cart Event database.”

Once the abstractions (e.g., token phrases, token sentences, token paragraphs, etc.) are generated, the system generates a visual representation of the technical diagram from the abstractions or groupings at 104. The visual representation simply includes the groupings represented as text and arranged in a sequence or order based upon a contextual relationship between the groupings. In other words, the system outputs the groupings as the text that is generated when creating the groupings and arranging them in a manner that makes semantic or contextual sense. Arrangement of the groupings can be performed utilizing any of the described methods or techniques for identifying context and arranging the entities within the different groupings.

At 105 the system determines whether a natural language summary can be generated from the visual representation. This determination may be made by applying a natural language processing technique on the visual representation. Since the technical diagram is now in text form, any natural language processing technique, for example, one or more conventional natural language processing techniques, can be applied to the visual representation. In the event that a natural language summary cannot be generated at 105, the system takes no action at 107, or, alternatively, provides an output indicating that a natural language summary cannot be provided. On the other hand, if a natural language summary can be generated at 105, the system may provide a natural language summary of the technical diagram at 106. Providing the natural language summary may include utilizing a summarization technique on the visual representation.

The system can utilize the visual representation in other applications. For example, in addition to creating a summary for the entirety of the technical diagram, the system may create a summary that can be used for title generation for the technical diagram. The system may also use the visual representation for responding to queries. For example, a user can provide a query regarding or related to the technical diagram. Since the visual representation is created, the query can be executed against the visual representation in order to provide a response to the query. Thus, the visual representation can be utilized to retrieve information from the technical diagram. The system can also perform other functions utilizing the visual representation, for example, identifying the next task in the technical diagram given a starting task, identifying a frequency of tasks occurring within the technical diagram, or the like.

An additional application that may utilize the visual representation is generating technical embeddings. One type of technical embedding is a semantic relationship technical embedding. The semantic relationship embedding assists in learning relationships between multi-classes. Classes are groupings of tokens and can be used, for example, to define rules on what tokens can or should be combined into a grouping. For example, the system may learn that some tokens can only be connected to particular types of tokens and cannot be connected to other types of tokens. Another type of technical embedding is a word representation embedding. A word representation embedding assists in learning token entities that are similar or have similar functions across different technical diagrams or technical diagram types or formats. For example, the system may learn that a “Load Balancer” token has the same or similar function as a “Router” token. Thus, the system can use context or relationships learned for one token as context or relationships for a similar token. Not only can these technical embeddings be used for future visual representation generations, but they may also be used to check the correctness of received technical diagrams or enrich received technical diagrams. In other words, the system can use the technical embeddings to determine if relationships or contexts illustrated in the received technical diagram are possible or accurate.

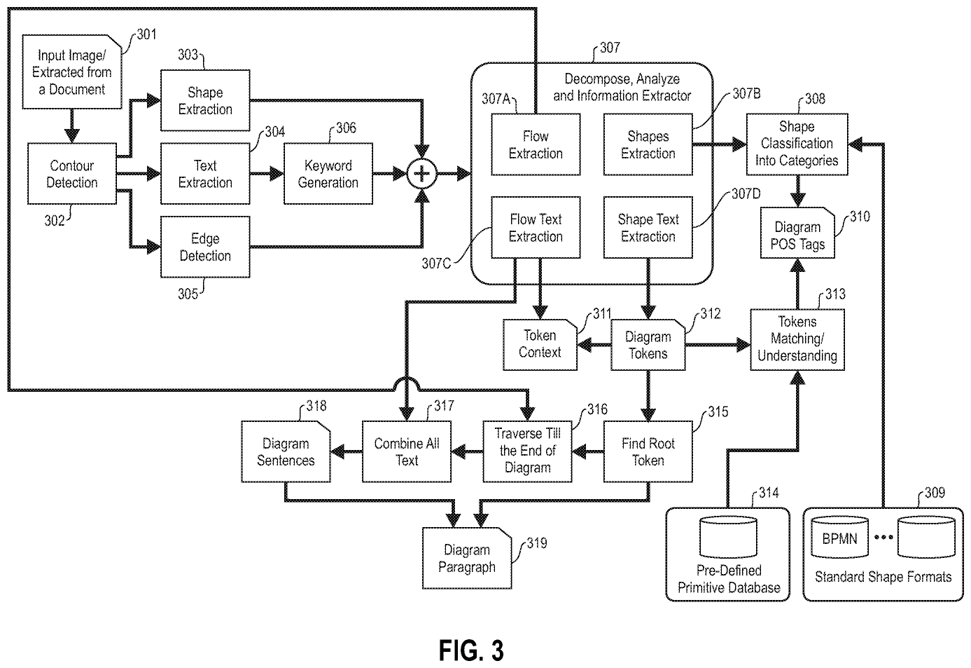

FIG. 3 illustrates an overall system architecture diagram. The technical diagram, which may include an input image or an image extracted from a document 301, may be provided to a contour-detection component 302 that detects contours within the technical diagram that can be used to identify edges, nodes, shapes, and text. The shape-extraction component 303, text-extraction component 304, and edge-detection component 305, extracts the shapes, text, and edges, respectively, from the technical diagram. From the text, the keyword-generation component 306 generates keywords that may correspond to entities within the technical diagram. The shapes, edges, and keywords are then aggregated and sent to the decomposition-analysis-and-information-extraction component 307. This component 307 includes a flow-extraction component 307A for extracting the technical diagram flow, shape-extraction component 307B for extracting and identifying the shapes of the technical diagram, flow-text-extraction component 307C that identifies entities within the technical diagram, and shape-text-extraction component 307D which identifies entities associated with text within shapes of the technical diagram.

The shape-extraction component 307B provides input to a shape-classification-into-categories component 308 that classifies the shapes into functional categories. To perform this classification, the shape-classification-into-categories component 308 accesses a database of standard shape formats 309, for example, BPMN (business process model notation) format. The flow-text-extraction component 307C provides input to the token-context component 311 which identifies a context of the token within the technical diagram. In identifying the context, the token-context component 311 takes input from the diagram-tokens component 312 which receives input from the shape-text-extraction component 307D. The diagram-tokens component 312 generates tokens from objects other than text within the technical diagram. The diagram-tokens component 312 also provides input to a tokens-matching-and-understanding component 313 which attempts to map textual primitives or tokens to visual primitives. The mapping can be assisted utilizing the predefined-primitive database 314. The tokens-matching-and-understanding component 313 provides input to the diagram-parts-of-speech-tags component 310 which also receives input from the shape-classification-into-categories component 308. The diagram-parts-of-speech-tags component 310 provides the functionality of a token as a diagram tag.

The diagram-tokens component 312 provides output to the find-root-token component 315 which identifies tokens within the technical diagram and determines a logical relationship between the tokens. Outputs from the find-root-token component 315 and flow-extraction component 307A are collected while the system traverses the diagram until the end of the diagram is reached at 316. The system then combines all of the tokens from 316 and the flow-text-extraction component 307C at 317. From the combined tokens the system can utilize the diagram-sentences component 318 to create token sentences. The token sentences and the root tokens from the find-root-token component 315 can be provided to the diagram-paragraph component 319 to generate the token paragraphs which are then combined into the visual representation.

Thus, the described systems and methods represent a technical improvement over current systems for producing summaries for technical diagrams. The described system and method provide a technique that automates and allows the conversion of a technical diagram into a visual representation that can be understood and analyzed utilizing standard natural language processing techniques. Thus, rather than having to program or train conventional natural language processing techniques on all different formats of technical diagrams, the described system instead converts any format of technical diagram to the visual representation which is easily understood utilizing conventional natural language processing techniques, thereby eliminating the need to train the conventional natural language processing techniques on technical diagram formats. Accordingly, the described system and method provide a technique for analyzing technical diagrams of any format and providing natural language output related to the technical diagram that is more efficient, faster, and accurate than conventional techniques.

As shown in FIG. 4, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
receiving a technical diagram comprising a plurality of nodes and edges, wherein each edge connects two of the plurality of nodes;
extracting, from the technical diagram, entities represented within the technical diagram, wherein the entities are extracted from the nodes and edges;
creating groupings of entities from the extracted entities by grouping entities into groups based upon a logical relationship between the entities within a given group;
generating, from the groupings, a visual representation of the technical diagram, wherein the visual representation comprises the groupings being represented as text and arranged based upon contextual relationships between the groupings; and
providing a natural language summary of the technical diagram, wherein the providing comprises converting the visual representation into natural language text.

2. The method of claim 1, wherein the extracting comprises classifying a geometric shape of a node as an entity.

3. The method of claim 1, wherein the extracting comprises (i) extracting text within the technical diagram and (ii) classifying the text as an entity.

4. The method of claim 1, wherein the creating groupings comprises grouping entities into logical groupings representing sentences of entities by identifying a semantic relationship between entities.

5. The method of claim 4, wherein the creating groupings comprises grouping sentences into logical groupings representing paragraphs of entities.

6. The method of claim 1, wherein the creating groupings comprises (i) assigning a parts-of-speech tag to each entity within a given grouping and (ii) ordering the entities within the given grouping utilizing the parts-of-speech tags within the given grouping.

7. The method of claim 1, wherein the creating groupings comprises identifying a logical relationship by identifying nodes connected by edges through a path within the technical diagram.

8. The method of claim 1, wherein the creating groupings comprises (i) extracting context from the technical diagram and (ii) identifying a logical relationship between entities based upon the extracted context.

9. The method of claim 1, wherein the converting comprises utilizing a natural language processing analysis technique on the visual representation.

10. The method of claim 1, comprising receiving a query related to the technical diagram; and
providing a response to a query by executing the query on the visual representation.

11. An apparatus, comprising:
at least one processor; and
a computer readable storage medium having computer readable program code embodied therewith and executable by the at least one processor, the computer readable program code comprising:
computer readable program code configured to receive a technical diagram comprising a plurality of nodes and edges, wherein each edge connects two of the plurality of nodes;
computer readable program code configured to extract, from the technical diagram, entities represented within the technical diagram, wherein the entities are extracted from the nodes and edges;
computer readable program code configured to create groupings of entities from the extracted entities by grouping entities into groups based upon a logical relationship between the entities within a given group;
computer readable program code configured to generate, from the groupings, a visual representation of the technical diagram, wherein the visual representation comprises the groupings being represented as text and arranged based upon contextual relationships between the groupings; and
computer readable program code configured to provide a natural language summary of the technical diagram, wherein the providing comprises converting the visual representation into natural language text.

12. A computer program product, comprising:
a computer readable storage medium having computer readable program code embodied therewith, the computer readable program code executable by a processor and comprising:
computer readable program code configured to receive a technical diagram comprising a plurality of nodes and edges, wherein each edge connects two of the plurality of nodes;
computer readable program code configured to extract, from the technical diagram, entities represented within the technical diagram, wherein the entities are extracted from the nodes and edges;
computer readable program code configured to create groupings of entities from the extracted entities by grouping entities into groups based upon a logical relationship between the entities within a given group;
computer readable program code configured to generate, from the groupings, a visual representation of the technical diagram, wherein the visual representation comprises the groupings being represented as text and arranged based upon contextual relationships between the groupings; and
computer readable program code configured to provide a natural language summary of the technical diagram, wherein the providing comprises converting the visual representation into natural language text.

13. The computer program product of claim 12, wherein the extracting comprises classifying a geometric shape of a node as an entity.

14. The computer program product of claim 12, wherein the extracting comprises (i) extracting text within the technical diagram and (ii) classifying the text as an entity.

15. The computer program product of claim 12, wherein the creating groupings comprises grouping entities into logical groupings representing sentences of entities by identifying a semantic relationship between entities.

16. The computer program product of claim 12, wherein the creating groupings comprises (i) assigning a parts-of-speech tag to each entity within a given grouping and (ii) ordering the entities within the given grouping utilizing the parts-of-speech tags within the given grouping.

17. The computer program product of claim 12, wherein the creating groupings comprises identifying a logical relationship by identifying nodes connected by edges through a path within the technical diagram.

18. The computer program product of claim 12, wherein the creating groupings comprises (i) extracting context from the technical diagram and (ii) identifying a logical relationship between entities based upon the extracted context.

19. The computer program product of claim 12, comprising receiving a query related to the technical diagram; and
providing a response to a query by executing the query on the visual representation.

20. A method, comprising:
receiving a diagram comprising nodes and edges, wherein each edge connects two of the nodes;
generating tokens corresponding to entities within the diagram, wherein the generating comprises utilizing at least one information extractor to extract objects from the nodes and edges;
grouping the tokens into logical groupings, wherein a given logical grouping comprises tokens having a contextual relationship within the diagram;
representing the logical groupings as a visual representation, wherein the visual representation comprises the logical groupings (i) arranged and (ii) connected by identifying a contextual relationship between the logical groupings; and
producing a natural language summary of the diagram by converting the visual representation into natural language text, the converting comprising utilizing a natural language processing analysis technique on the visual representation.
